(19) United States
(12) Patent Application Publication
(10) Pub. No.: US 2004/0165944 A1
(43) Pub. Date: Aug. 26, 2004

(54) Attachment/detachment tape

(76) Inventors: Donald V. Varanese, Mentor, OH (US); Edward Andrew Armijo, Mentor, OH (US); Michael D. Hilston, Painesville, OH (US); Johannes H. de Jong, Turnhout (NL)

Correspondence Address: CALFEE HALTER & GRISWOLD, LLP, 800 SUPERIOR AVENUE, SUITE 1400, CLEVELAND, OH, 44114, US

(21) Appl. No.: 10/741,679

(22) Filed: Dec. 19, 2003

Related U.S. Application Data
(60) Provisional application No. 60/435,649, filed on Dec. 20, 2002.

(51) Int. Cl. F16B 12/04

(52) U.S. Cl. 403/266

(57) ABSTRACT

An attachment/detachment fastening system comprising a backing, an adhesive on one side of the backing, and a weakened joint in the backing whereby the backing is foldable and tearable along the weakened joint. The backing and adhesives for the fastening system are chosen based on the end application. Suitable backing materials include polymers, papers, and metal foils. Suitable adhesives include pressure-sensitive adhesives and heat-set adhesives. The weakened joint may be formed by mechanical means, such as scoring, slitting, or perforating the backing, or by chemical means such as acid dripping or etching. The fastening system of the present invention is useful in various applications, including joining together products for shipping and sale, e.g., attaching a promotional product to a product to be sold, and as tamper-evidence labels.

### CROSS-REFERENCE TO RELATED APPLICATIONS

This application claims priority to U.S. Provisional Application Serial No. 60/435,649, filed Dec. 20, 2002, the entirety of which is incorporated herein by reference.

### BACKGROUND OF THE INVENTION

The present invention relates generally to a fastening system comprising an attachment/detachment tape. The inventive fastening system is useful for attaching two or more articles for promotional or other purposes; the attached articles are easily separable by consumers. Once separated, the fastening system preferably leaves no exposed adhesive on the articles, which could cause contamination or storage issues. The present invention also relates to a fastening system useful for applications in which evidence of tampering is desired or necessary.

Double-sided adhesive tapes are known in the art. While double-sided adhesive tapes are useful for many applications, they are not well-suited for removably adhering two articles together without leaving adhesive on one or both articles when the articles are separated. This exposed adhesive attracts dirt and contaminants, and is unattractive to consumers. The removed double-sided tape must also be handled and disposed of by the consumer.

Hot melt adhesives are also known for joining two articles together. The hot melt adhesive is applied directly to the articles that are to be held together. When the consumer separates the articles, the sticky adhesive mass is left behind. Unfortunately, this adhesive mass can pose a choking hazard for young children.

In addition to the above-mentioned disadvantages, while double-sided adhesive tape and hot melt adhesives can adhere two objects together, neither satisfactorily provide tamper evidence if the articles are separated from each other before they reach the consumer.

Accordingly, it is desirable to have a fastening system that is capable of holding two or more articles together until separated by an end user, but that does not have the disadvantages of leaving a sticky residue on one or more of the packages, or have any removable adhesive that may pose a choking hazard to young children.

One advantage of the present invention is that two or more articles are securely adhered together during shipping and sale, and then are easily separable by the end-consumer, preferably leaving no exposed adhesive on one or more of the packages. A further advantage of the inventive fastening system is that when the articles are separated, the fastening system itself separates along a weakened joint in the backing. When separated, only the backing is exposed, rather than the sticky adhesive. Still a further advantage of the present invention is that the fastening system may be tailored to many different applications. For example, a clear, colorless backing may be used so that when the attached articles are separated, the printing on the articles beneath the backing is readable. For other applications, the fastening system may be opaque, colored, patterned, printed, and so forth.

### SUMMARY OF THE INVENTION

The present invention provides a versatile fastening system comprising a backing, an adhesive on one side of the backing, and a weakened joint in the backing. The fastening system is foldable and tearable along the weakened joint. The joint may comprise perforations, one or more slits, or scores in the backing, or a combination thereof.

The backing material used in accordance with the inventive fastening system comprises any known backing materials that are capable of being foldable and tearable. Some particularly suitable backing materials include polymers, including, but not limited to polyethylene terephthalate, polybutylene terephthalate, polyethylene, polypropylene; copolymers such as poly(ethylene-propylene), poly(ethylene-vinyl acetate), and poly(styrene-butadiene); and blends thereof.

The adhesive used in the fastening system may comprise any known adhesive. Preferred adhesives include pressure-sensitive adhesives and heat-set adhesives. Preferred pressure-sensitive adhesives include rubber adhesives, acrylic adhesives, solvent adhesives, and silicone adhesives. Preferred heat-set adhesives include solvent adhesives, hot melt adhesives, and emulsion adhesives.

The tearability of the inventive attachment/detachment tape fastening system may be adjusted according to the particular application. In many applications, the fastening system will be separable or tearable without the aid of a mechanical assist. In other applications, it may be desirable that the fastening system is separable or tearable only with the aid of a mechanical assist, such as a scissors, knife, or similar. In accordance with the present invention, it is generally desired that the force required to tear the attachment/detachment tape fastening system along a weakened joint or joints is less than the force required to peel the backing from the articles once the articles are adhered together.

The present invention further comprises a method of securing two or more objects together using the inventive fastening system. In one embodiment, the attachment/detachment tape fastening system of the present invention comprises a tape backing having an adhesive coating on one side and a weakened joint in the backing. The weakened joint comprises perforations, slits, scoring, or similar, such that the backing can be folded along and, at a later time, separated along the weakened joint. When separated along the weakened joint, the objects are separated. The separated fastening system remains on the object, with only the backing exposed, thus minimizing the exposed adhesive.

The attachment/detachment tape fastening system may be cut into any desired shape, for example, a strip, a sheet, a circle, or similar. To adhere two or more objects together, the selected shape is folded along the weakened joint or joints, such that the adhesive is facing outwards. The adhesive is used to adhere two objects together. When two or more objects are being adhered for promotional or similar purposes, multiple pieces of the inventive fastening system may be used to decrease the chance that the adhered articles may separate before reaching the consumer. In other applications, such as when the inventive fastening system is a tamper-evidence label for a mailing envelope, a single piece may be used.

In a more preferred embodiment, the attachment/detachment tape fastening system of the present invention comprises a backing, an adhesive on one side of the backing, and two weakened joints in the backing, as depicted in FIG. 1. The fastening system is folded along the two weakened joints, and used to adhere two or more articles together. The articles then remain adhered together until separated by the consumer. This embodiment can also be used as a tamper-evidence label for sealing packages or envelopes for mailing or sending via courier.

In one preferred embodiment, the attachment/detachment tape of the present invention is in rolls. The rolls can be cut to strips of the desired length for a particular application. The rolls may have a release liner. In a preferred embodiment, a low surface energy coating, such as silicone, is applied to the obverse side of the backing. When a low surface energy coating is used on the obverse, no release liner is necessary.

### BRIEF DESCRIPTION OF THE DRAWINGS

FIG. 1 is a representative view of the inventive attachment/detachment fastening system showing the fastening system before and after inclusion of the weakened joint.

FIG. 2 depicts an apparatus for mechanically folding the inventive attachment/detachment fastening system and a proposed applicator method for the inventive attachment/detachment fastening system.

FIG. 3 depicts a proposed production line configuration for the inventive attachment/detachment fastening system.

### DETAILED DESCRIPTION OF THE INVENTION

The inventive fastening system comprises an adhesive tape that is capable of being folded and torn or separated on or along a pre-made weakened joint.

In one embodiment, the fastening system is used to attach one or more promotional samples to a related product. For example, a shampoo manufacturer may removably attach a trial-sized sample of conditioner to a bottle of shampoo using the attachment/detachment tape fastening system of the present invention. Similarly, a diaper manufacturer may use the attachment/detachment tape fastening system of the present invention to removably attach a trial-sized package of baby wipes and a coupon for a future purchase to a package of diapers. The attachment/detachment tape fastening system of the present invention may also be used to attach full-sized products together for two-for-one promotions. In each example, the articles may be adhered together with the inventive attachment/detachment tape fastening system prior to shipping to the point-of-sale. The articles remain adhered together until purchased and separated by the end consumer. By pulling the articles apart, the attachment/detachment tape fastening system tears along the weakened joint or joints in the backing. When torn along the weakened joint or joints in the backing, the torn attachment/detachment tape remains on the separated articles, with only the backing exposed. The separated articles preferably have no exposed adhesive from the attachment/detachment tape fastening system on them.

The adhesive used in the fastening system is generally chosen such that it will have good peel adhesion properties with respect to the articles to be joined together. The adhesive is chosen such that the bond of the adhesive to the articles is stronger than the force required to tear or separate the attachment/detachment tape along the weakened joint.

In another embodiment, the attachment/detachment tape fastening system of the present invention serves as a tamper-evidence label. In this embodiment, a permanent adhesive may be used to ensure that the tamper-evidence label can only be removed by tearing along the weakened joint and not by peeling the adhesive from the article. When used as a tamper-evidence label, it may further be desirable to print a message on the attachment/detachment tape informing the end-user of the tamper-evidence function. Alternatively, the tamper-evidence function may be printed directly on the envelope so that it may be seen through a clear attachment/detachment tamper-evidence fastening system.

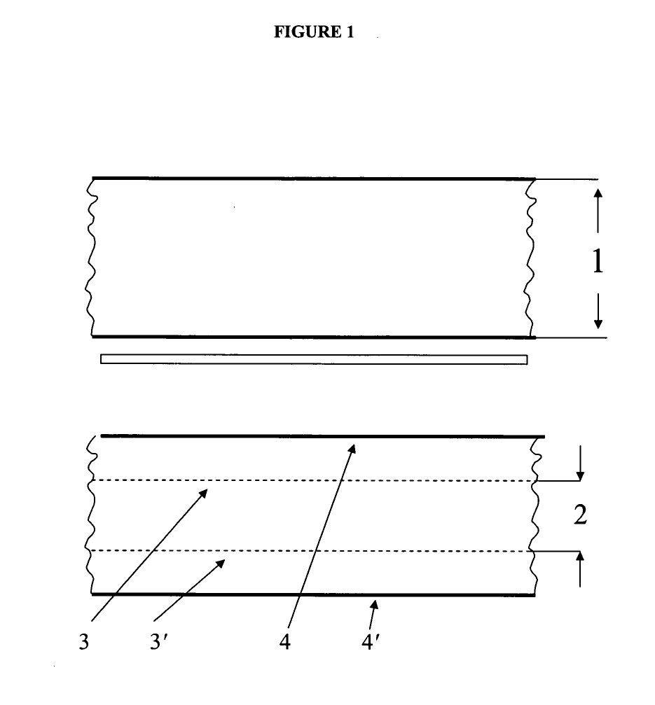

Referring to FIG. 1, 1 is the width of a roll of the inventive attachment/detachment tape fastening system. The width 1 can be modified based upon the size and weight of the articles that will be removably adhered together. 2 depicts a possible configuration for two weakened joints in the backing, represented by 3 and 3′. In the embodiment shown, the weakened joint comprises a plurality of perforations. The attachment/detachment tape fastening system is folded along the two weakened joints by folding outer edges 4 and 4′ towards the center of the tape so that the adhesive is exposed on both the top and the bottom of the attachment/detachment tape fastening system. The fastening system is then ready to adhere two or more articles together. The articles may be adhered together at any convenient point in the manufacturing, shipping, or sale process. For example, it may be desirable to secure a promotional item to a related product before shipping to a point of sale location. The attachment/detachment tape fastening system of the present invention is capable of holding the products together during final packaging, shipping, and display in a store. The articles are adhered together securely until separated by the end consumer, through the action of tearing the attachment/detachment tape along the weakened joint or joints. After separation, the backing remains adhered to the articles, minimizing any exposed adhesive.

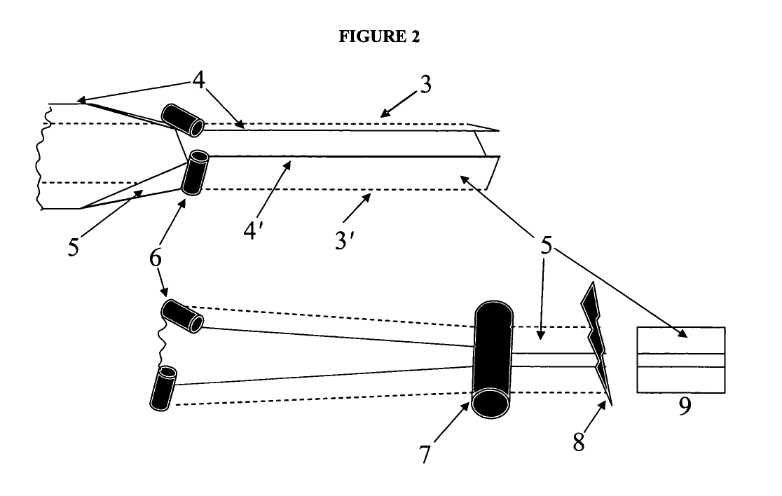

FIG. 2 depicts a simple, but unique design for mechanically folding the attachment/detachment tape fastening system and then subsequently cutting pieces of the folded fastening system to a desired length. A length of the attachment/detachment tape fastening system is shown with the backing facing up, and the adhesive coating 5 initially facing downwards. The attachment/detachment tape passes through rollers 6 which fold the attachment/detachment tape along the weakened joints 3 and 3′. Upon folding, edges 4 and 4′ end up nearer to the center of the tape, and the exposed adhesive 5 (shown in gray) is now exposed on both the top and bottom of the attachment/detachment tape. The folded fastening system then passes under a pressure-laminating roller 7 and is subsequently cut to a desired length by a knife or blade 8. The cut length of the attachment/detachment tape fastening system can be used at this point to adhere two or more articles together, or could be packaged for use at a subsequent time or other location. If the attachment/detachment tape fastening system will be used at a later time, a release liner could be added to aid in storage or shipping. It is recognized that other mechanical means may be employed to fold and cut the inventive fastening system.

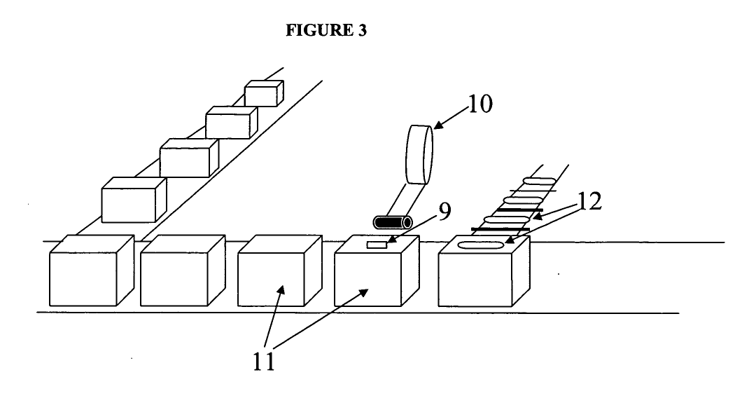

FIG. 3 depicts a proposed production line configuration for such a fastening system. A roll of the fastening system 10 is folded and cut to strips slightly shorter in length than promotional item 12. The attachment/detachment tape fastening system is adhered to article 11. Promotional item 12 is then adhered to article 11. The attached articles can then be shipped, displayed, and sold as usual. Accordingly, the two articles stay attached together until the attachment/detachment tape fastening system is separated along the weakened joint by the consumer.

Definitions

As used herein, the word “tearable” means capable of being torn or separated, either manually or with the aid of a mechanical assist, such as a scissors, knife, or similar. The terms “tearable” and “separable” are interchangeable for the purposes of this application.

The phrase “weakened joint” refers to one or more scores, slits, or perforations made in a backing, either by mechanical or chemical means, which facilitate foldability and tearability of the backing along the weakened joint. The weakened joint may be any shape or pattern, and can be oriented in any way that is conducive to facilitating foldability and tearability. Some non-limiting examples of configurations for the weakened joint include straight, linear patterns of perforations, slits, or scores; curvilinear patterns of perforations, slits, or scores; angular patterns of perforations or scores, and the like. The weakened joint may also comprise any combination of perforations, slits, and scores used together. This includes such combinations as perforations superimposed over a score, as well as alternating use of scores, slits and perforations.

The word “perforations” as used herein refers to a plurality of holes made in the backing, that facilitate folding and tearing. “Perforations” includes a plurality of holes wherein a majority of the holes extend completely through the backing. “Perforations” also includes a plurality of holes wherein only some of the holes extend completely through the backing and some do not extend through the backing. “Perforations” also includes a plurality of holes, wherein a majority of the holes do not extend through the backing. Stated otherwise, “perforations,” as used herein, connotes a plurality of holes that facilitate folding and tearing the backing along those holes. The word “perforations” does not connote any specific depth of those holes with respect to the backing. “Perforations” further includes “slits,” whether the slits extend through the backing, or not. Perforations may be any size and shape. The size and shape of the perforations will depend on the shape of the die or knife used to make the perforations. The distance between the perforations may be varied according to the application.

The perforations, slits and scores that provide the weakened joint may be continuous, intermittent, or discontinuous. “Continuous” connotes that the perforations, slits, or scores forming the weakened joint are uninterrupted along the length of the weakened joint. “Intermittent” connotes that the perforations, slits, or scores along the weakened joint have interruptions at regular intervals. “Discontinuous” connotes that the perforations, slits, or scores may have interruptions, but those interruptions do not necessarily appear to be in a regular intervals. When intermittent or discontinuous, the separation between perforations, slits, or scores may vary depending on several factors. Such factors include: the size and weight of the articles that are to be secured together, the materials the articles are made of, and so forth.

As used herein, the term “plurality” refers to a number greater than one. As used herein, the term plurality does not connote an upper limit. The term “majority” as used here refers to more than fifty percent. For example, the phrase “a majority of the perforations extend completely through the backing” means that more than fifty percent of the perforations extend completely through the backing.

The Backing

For the purposes of this application, the term “backing” is used interchangeably with the term “facestock.” In accordance with the present invention, the backing material may be any known backing or facestock material that is capable of receiving an adhesive and capable of having a weakened joint made therein, wherein the weakened joint is foldable and separable. The backing material will likely be chosen based on the particular application, and, therefor, is not limited to any specific materials. Some examples of backing materials include polymers, papers, and metal foils.

Polymeric backing materials may comprise film-forming thermoplastic materials, such as polyesters or polyolefins. If desired, these materials may be cast or oriented. Examples of polyester materials include polyethylene terephthalate and polybutylene terephthalate films. Examples of polyolefins include polyethylene and polypropylene; copolymers, such as poly(ethylene-propylene), poly(ethylene-vinyl acetate), and poly(styrene-butadiene); and blends thereof. The thickness of the backing will vary according to the particular application. The polymer backing may have a matte or glossy finish as well as a smooth or irregular (e.g., embossed) surface.

Backing materials generally come in a uniform-sized web. Conveniently, the fastening system of the present invention can be manufactured from such materials, using conventional web processing equipment. While the examples disclosed herein generally refer to conventional size and shaped backing materials, it is noted that those skilled in the art would readily recognize that the fastening system of the present invention could be prepared from backing material of any size and shape by adapting existing equipment. Those skilled in the art will recognize adjustments that may be made to accommodate unconventional-shaped backing materials.

In a preferred embodiment, the side of the backing material that will not receive the adhesive is coated with a low surface energy coating, such as silicone. The low surface energy coating prevents the adhesive from bonding to the backing when the attachment/detachment tape is wound on a roll.

Since the backing material remains on the articles after the attachment/detachment tape fastening system is separated, the backing material may be chosen for its appearance after separation. It may be desirable to choose a clear, colorless backing material when there is information on the articles that will be revealed when the articles are separated from each other. Alternatively, it may be desirable to include printed matter, patterns, or designs, which may be functional or decorative in nature, on the backing material.

When the fastening system is used as a tamper-evidence label, it may be desirable to print a message informing a recipient of that function. When the fastening system is used to adhere two or more objects together, on the other hand, it may be desirable to have a clear, colorless backing so that the end user can read instructions or other printed materials located beneath the backing after separation.

For convenience, when printing is desired on the fastening system, the printing will generally be done prior to the application of the silicone coating, if used. If a silicone coating is not used, the printing will generally be done prior to application of the adhesive. However, it is recognized that the printing step could be done at other stages in the production process.

The Adhesive

Like the backing materials, the adhesives of the present invention are not limited to any particular adhesive or set of adhesives. Rather, the adhesive is chosen based on each particular application. Any known adhesive can be used in accordance with the present invention.

Preferred classes of adhesives include pressure-sensitive adhesives and heat-set adhesives. Both types of adhesives are well-known in the industry. Pressure-sensitive adhesives can be chosen from, for example, rubber, acrylic, solvent, and silicone adhesives. Heat-set adhesives include solvent, hot melt, and emulsion adhesives. Other adhesives may also be used if better-suited for a particular application. Single layer or multi-layer adhesives may be used.

The adhesive may be applied to the backing by any method known in the art, including but not limited to dip coating, slot dye coating, spray coating, and the like. The adhesive can be applied as a continuous layer, or a discontinuous pattern on the backing. When the adhesive is applied as a coating, the coating weight of the adhesive will depend on such factors as the adhesive used, the backing material used, and the end application. Those skilled in the art will readily be able to determine a coating appropriate to the particular application.

In accordance with the present invention, the adhesive is generally chosen such that a greater force is required to remove the adhesive from the attached objects than is required to separate the fastening system along the tearable joint. In some specific applications, such as when the fastening system is used to fasten an envelope and provide tamper evidence if the envelope has been opened, the adhesive chosen may be may adhere to the envelope surfaces with a much stronger bond than otherwise necessary based on the force needed to tear the fastening system along the weakened joint. This helps to ensure that the envelope cannot be tampered with by peeling away the actual adhesive tape without tearing along the weakened joint to bypass the tamper-evidence function.

It is recognized that, depending on the application, some adhesives will have the desired level of adhesion initially, while for other applications, the dwelled adhesion, i.e., the adhesion after the adhesive has had a chance to wet out after application to an article, will be desired. In still other applications, the adhesive may initially be a pressure-sensitive adhesive, which is then cured to a permanent adhesive. Its is further recognized that the adhesive chosen will depend not only on the surface of the articles to be joined together and the adhesion desired, but will also depend on environmental considerations, such as whether the adhered articles will be stored indoors or outdoors; storage humidity levels; and temperature considerations, such as whether the adhered articles will be stored at room temperature, in a refrigerator, or freezer, or at varying temperatures. Each of these parameters and others will typically be considered for individual applications, and the necessary adjustments are within the scope of this invention.

While it is not necessary with the preferred embodiments, in some applications, a release liner may be desired. Appropriate materials for release liners are generally known in the art. When a release liner is desired, it can be joined to the tape at any convenient location in the processing line. For example, the release liner may be joined prior to rolling the coated backing material. In the preferred embodiment, no release liner is used, but the side of the backing that will not receive the adhesive is coated with a low surface energy coating, preferably, a silicone coating. This low surface energy coating allows the adhesive-coated tape to be wound into rolls without the adhesive bonding to the non-adhesive coated side of the backing.

The Weakened Joint

Another aspect of the inventive fastening system is the weakened joint along which the backing can be folded and torn. The weakened joint can be formed in the facestock layer by mechanical or chemical techniques. Mechanical techniques include forming discontinuities along an intended failure line as by scoring, perforating, slitting, or any other means known in the art. Chemical techniques include acid drip or etching. The weakened joint can be made in the backing at any convenient time in the manufacturing process. Preferably, the weakened joint is made after the backing is coated with adhesive and slit into rolls of the desired width.

In a preferred embodiment, the attachment/detachment tape fastening system includes two weakened joints. This allows two or more objects to be held together satisfactorily with a single piece of the attachment/detachment tape fastening system. Alternatively, such as when the attachment/detachment tape fastening system has only one weakened joint, two or more pieces of the fastening system may be used to secure two or more articles together to lessen the chance of premature separation.

The weakened joint facilitates folding of the fastening system so that the adhesive of the fastening system can be employed to adhere two or more objects together. Once adhered, the fastening system prevents the objects separating from each other prematurely, i.e., before being manually separated by the end-user. The end-user may be a consumer when the inventive fastening system is used for promotional bundling, or an intended recipient when used in tamper-evidence applications. The weakened joint further allows the end user to cleanly separate the objects from each other. When the objects are pulled apart, the adhesive tape of the fastening system tears or separates along the weakened joint, leaving only the non-adhesive surface of the backing exposed on each object. Accordingly, after the objects have been separated, preferably no adhesive is exposed.

Preparation of the Attachment/Detachment Tape Fastening System

The attachment/detachment fastening system may be prepared by conventional tape preparation means. A role of facestock, or backing, is loaded onto a conventional unwind system and a guide is used to align the web. As the web unwinds, a corona treater is used to form an oxidized film on the facestock. The side of the facestock that will not receive adhesive is preferably coated with a silicone coating. The silicone coating provides a low surface energy that the adhesive will not bond to when the attachment/detachment tape is rewound into rolls. The silicone coating can be cured by any method; electron beam curing and UV curing are examples of two conventional curing techniques. A film caliper gauge can then be used to assure uniform thickness.

The side of the facestock that has not been coated with silicone is then coated with the desired adhesive by conventional coating techniques. The particular coating method will vary depending on such factors as the adhesive used, the desired coating weight, the coating speed, the desirability of patterning, and the like. Each of these parameters are readily ascertainable by those skilled in the art without any undue experimentation. For example, if coating a continuous non-patterned hot melt adhesive, a slot die or roll coater is appropriate. After receiving the adhesive, the facestock is chilled to set the adhesive, and then rewound. The rolls are then slit into narrower rolls of the desired width, using a conventional slitter.

The weakened joint or joints are then made in the backing. Preferably, the weakened joint is made by mechanical means. The weakened joint may be a score line that does not extend all of the way through the thickness of the backing; perforations, ranging from indentations in the backing to extending completely through the backing; or slits, which may or may not extend completely through the backing. The preparation of the weakened joint will depend on such factors as the backing material used, the size and weight of the articles that will be adhered together, the particular adhesive, and so forth.

The weakened joint may be made mechanically by such methods as scoring, as with a blade, perforating, slitting, or any combination thereof. For perforations, the size, depth, and distance between perforations may all be adjusted in accordance with various methods known in the art. Various dies for making perforations are known, including light, medium, and tight dies. The perforator may have male and female sections, or may be used with an anvil tool. Alternately, the backing may be kiss-cut, wherein a plurality of the perforations do not penetrate the backing material, but the backing material may still be torn satisfactorily.

While it is preferred that the weakened joint is made in the backing after the adhesive coating is applied, it is recognized that the weakened joint can be made in the backing at any convenient step in the manufacturing process.

When printing on the facestock is desired, it is generally done before the application of the silicone, if a silicone coating is used. If a silicone coating is not used, the printing is preferably done before application of the adhesive. If a release liner is desired, the release liner can be added at the appropriate stage in the process.

The preparation outlined above is illustrative of one method of producing the attachment/detachment tape fastening system of the present invention. Those skilled in the art will recognize that the inventive attachment/detachment tape fastening system could be produced by numerous other methods.

### EXAMPLE 1

### Preparation of a Roll of the Attachment/Detachment Fastening System

An attachment/detachment fastening system was prepared by coating 4 mil polypropylene backing with a pressure-sensitive rubber adhesive by conventional means. The side of the backing that would not receive adhesive was previously coated with a silicone coating, to prevent the adhesive from bonding with the backing when the adhesive-coated backing was rewound. The coated polypropylene was slit to rolls 3 inches in width. After slitting, 0.250 cut/0.020 tie perforations were made in the backing, at a distance of 0.625 inches from each side, to form two weakened joints in the attachment/detachment tape fastening system. The fastening system was rewound into individual 3-inch wide rolls.

### EXAMPLE 2

### Use of the Attachment/Detachment Fastening System to Attach a Promotional Product to a Related Product

The fastening system of Example 1 was used to adhere a promotional baby wipes package to a diaper package. The attachment/detachment fastening system was cut into a strip slightly shorter in length than the length of the promotional baby wipes package. A strip of the fastening system was folded along the perforations and adhered to the diaper package. The baby wipes package was then secured to the diaper package using the fastening system. While the fastening system had good initial adhesion, the adhesion increased over the next 24 hours to the desired adhesion level. The baby wipes package was securely adhered to the diaper package for shipping and display at a store.

### EXAMPLE 3

### Separation of the Baby Wipes from the Diaper Package

A baby wipes package was adhered to a diaper package as in Example 2. The adhered packages were allowed to rest untouched for 24 hours, to allow the adhesive to wet out. After 24 hours, the baby wipes package was pulled away from the diaper package. As the baby wipes package was pulled away from the diaper package, the attachment/detachment tape fastening system tore along the weakened joint. The separated pieces of the attachment/detachment fastening system remained adhered to the baby wipes package and the diaper package, with only the backing exposed on each package. There was no exposed adhesive on either the baby wipes package or the diaper package.

### EXAMPLE 4

### Attachment of Two Promotional Items to an Article

A baby wipes package is adhered to a diaper package using the attachment/detachment tape fastening system, as in Example 2. After adhering the baby wipes package to the diaper package, a second strip of the attachment/detachment tape is cut and adhered to the baby wipes package. A coupon booklet is then removably adhered to the baby wipes package.

### EXAMPLE 5

### Attachment of Two Promotional Items to an Article

A roll of attachment/detachment tape fastening system is prepared as in Example 1. After making the 0.250 cut/0.020 tie perforations, at a distance of 0.625 inches from each side in the backing, scores are made perpendicular to the perforations, at a distance of two inches apart. The tape is rewound. Individual pieces of the attachment/detachment tape fastening system are removed at every other score, such that each 4-inch strip has a single score in the center. The attachment/detachment tape fastening system is folded along the perforations and attached to a container of laundry detergent. A sample of fabric softener is adhered to the laundry detergent on one side of the center score of the attachment/detachment tape. A coupon booklet is adhered to the attachment/detachment on the other side of the center score. The fabric softener sample and coupon book are securely adhered until separated by the consumer. When separated, only the backing is exposed on each of the articles; no adhesive is exposed.

### EXAMPLE 6

### Attachment of a Compact Disk to a Cereal Box

The attachment/detachment tape prepared in Example 1 is cut into strips just shorter in length than a compact disk. The strips are folded along the perforations and adhered to the cereal box. A package containing a compact disk is then adhered to the cereal box using the attachment/detachment tape fastening system. The compact disk remains attached to the box during shipping and sale. The compact disk package is removed by pulling away from the box to separate the attachment/detachment tape along the perforations. Only the backing is exposed on the cereal box and on the compact disk package.

### EXAMPLE 7

### Use of the Attachment/detachment Tape Fastening System as a Tamper-Evidence Label

A fastening system of Example 1 is used to fasten the flap of a courier-type envelope in the closed position. The envelope flap could not be lifted without tearing the weakened joints of the attachment/detachment tape fastening system. Accordingly, separation of the fastening system prior to detachment by the recipient offers evidence of tampering.

The invention claimed is:

1. A fastening system comprising:
a. a backing;
b. an adhesive on one side of the backing; and
c. a weakened joint in the backing;
wherein the fastening system is foldable and tearable along the weakened joint.

2. The fastening system of claim 1 wherein the backing is selected from the group consisting of polymers, metal foils, and paper.

3. The fastening system of claim 2 wherein the backing is a polymer.

4. The fastening system of claim 3 wherein the backing is a thermoplastic polymer.

5. The fastening system of claim 4 wherein the backing is selected from the group consisting of polyesters and polyolefins.

6. The fastening system of claim 5 wherein the backing is selected from the group consisting of polyethylene terephthalate, polybutylene terephthalate, polyethylene, polypropylene, poly(ethylene-propylene), poly(ethylene-vinyl acetate), poly(styrene-butadiene), copolymers thereof, and blends thereof.

7. The fastening system of claim 6 wherein the backing is polypropylene.

8. The fastening system of claim 1 wherein the adhesive is selected from the group consisting of pressure-sensitive adhesives and heat-set adhesives.

9. The fastening system of claim 8 wherein the adhesive comprises a pressure-sensitive adhesive.

10. The fastening system of claim 9 wherein the pressure-sensitive adhesive is selected from the group consisting of rubber, acrylic, solvent, and silicone adhesives.

11. The fastening system of claim 10 wherein the pressure-sensitive adhesive is a rubber adhesive.

12. The fastening system of claim 8 wherein the adhesive comprises a heat-set adhesive.

13. The fastening system of claim 12 wherein the heat-set adhesive is selected from the group consisting of solvent, hot melt, and emulsion adhesives.

14. The fastening system of claim 1 wherein the weakened joint comprises perforations, slits, scores, or combinations of perforations, slits, and scores.

15. The fastening system of claim 14 wherein the weakened joint is continuous.

16. The fastening system of claim 14 wherein the weakened joint is intermittent.

17. The fastening system of claim 14 wherein the weakened joint is discontinuous.

18. The fastening system of claim 14 wherein the weakened joint comprises perforations, wherein a plurality of the perforations penetrate completely through the backing material.

19. The fastening system of claim 14 wherein the weakened joint comprises perforations, wherein a majority of the perforations do not completely penetrate the backing material.

20. The fastening system of claim 14 comprising a score superimposed on perforations.

21. The fastening system of claim 1 wherein the fastening system is tearable along the weakened joint without a mechanical assist.

22. The fastening system of claim 1 wherein the fastening system is tearable along the weakened joint with a mechanical assist.

23. The fastening system of claim 1 further comprising a silicone coating on the obverse side of the backing.

24. The fastening system of claim 1 further comprising a release liner.

25. The fastening system of claim 1 wherein the fastening system comprises a roll.

26. The fastening system of claim 1 wherein the fastening system comprises a strip.

27. A method of securing at least two objects together, the method comprising the steps of:
a. adhering a fastening system comprising a backing, an adhesive on one side of the backing, and a weakened joint in the backing, to a first object;
b. folding the fastening system along the weakened joint; and
c. adhering a second object to the folded fastening system, whereby the second object is secured to the first object.

28. A method of securing at least two objects together, the method comprising the steps of:
a. folding a fastening system comprising a backing, an adhesive on one side of the backing, and a weakened joint in the backing, along the weakened joint;
b. adhering the folded fastening system to a first object; and
c. adhering a second object to the folded fastening system, whereby the two objects are secured to each other.

29. A tamper evidence label comprising a fastening system, the fastening system comprising a backing, an adhesive on one side of the backing, and a weakened joint in the backing.

30. A fastening system comprising:
a. a polymeric backing;
b. a pressure-sensitive adhesive on one side of the backing;
c. a first weakened joint in the backing; and
d. a second weakened joint in the backing;
wherein the fastening system is foldable and tearable along the first weakened joint and along the second weakened joint.

31. The fastening system of claim 30 wherein the polymeric backing is polypropylene.

32. The fastening system of claim 30 wherein the pressure-sensitive adhesive is a rubber adhesive.

33. The fastening system of claim 30 wherein the first weakened joint and the second weakened joint are perforations.

34. The fastening system of claim 33 wherein a plurality of the perforations do not completely penetrate the backing.

35. The fastening system of claim 30 wherein the first weakened joint and the second weakened joint are approximately parallel to each other.

36. The fastening system of claim 30 wherein the fastening system comprises a roll.

37. The fastening system of claim 30 wherein the fastening system comprises a strip.

38. An attachment/detachment tape fastening system comprising:
a. a polymeric backing;
b. a silicone coating on one side of the polymeric backing;
c. an adhesive on the other side of the polymeric backing; and
d. a weakened joint in the backing;
wherein the attachment/detachment tape fastening system is foldable and tearable along the weakened joint.

39. The attachment/detachment tape fastening system of claim 38 further comprising a second weakened joint in the backing.

40. The attachment/detachment tape fastening system of claim 39 wherein the weakened joint comprises perforations, slits, scores, or combinations of perforations, slits, and scores.

41. The attachment/detachment tape fastening system of claim 38 wherein the first weakened joint and the second weakened joint comprise perforations, slits, scores, or combinations of perforations, slits, and scores.
